(19) United States
(12) Patent Application Publication
(10) Pub. No.: US 2010/0000420 A1
(43) Pub. Date: Jan. 7, 2010

(54) Spit driving device with lighting means for rotisserie device

(76) Inventor: Jia-Rurng Chang, Taipei (TW)

Correspondence Address: JIA-RURNG CHANG, P.O. BOX 24-108, TAIPEI, TW

(21) Appl. No.: 12/217,255

(22) Filed: Jul. 3, 2008

(51) Int. Cl. A47J 37/07

(52) U.S. Cl. 99/421 H

(57) ABSTRACT

A spit driving unit mounted on one side of the housing of a rotisserie device for rotating a spit is disclosed to include a light source for emitting light toward the roasting chamber for enabling the user to visually check the roasting condition of the meat when it is dark, an adjustment handle for adjusting the light emitting direction of the light source, and a switch for switching on/off the light source.

### BACKGROUND OF THE INVENTION

1. Field of the Invention

The present invention relates to rotisserie device and more particularly, to a spit driving device for rotisserie device that is equipped with a light source for enabling the user to visually check the roasting condition of the meat when it is dark.

2. Description of the Related Art

During a holiday, people may invite friends to have a barbecue party. For roasting meat during a barbecue party, a rotisserie device shall be used. FIG. 1 illustrates a conventional rotisserie device. According to this design, the rotisserie device comprises a housing 10 defining a roasting chamber, a casing 13 fixedly mounted on a bracket 13 at one side of the housing 10, and a motor (not shown) mounted inside the casing 13 and having tubular output shaft 142 extended out of the casing 13 for the connection of a spit 15 for enabling the motor to rotate the spit 15 on the top open side of the housing 10.This design of rotisserie device is convenient in use, however it is still not satisfactory in function. When it is dark, the user may be difficult to visually check the roasting condition of the meat. When visually checking the roasting condition of the meat under a dark environment, the user may have to move the head toward the rotisserie device so as to see the meat better. The waste smoke may irritate the user's eyes when the user approaches the rotisserie device. Further, a light source may be attached to the rotisserie device for illumination. However, the installation and storage of the attached light source are inconvenient. Further, the light source tends to be covered with waste dust and grease.

### SUMMARY OF THE INVENTION

The present invention has been accomplished under the circumstances in view. It is one object of the present invention to provide a spit driving device for rotisserie device, which is equipped with a light source for enabling the user to visually check the roasting condition of the meat when it is dark.

To achieve this and other objects of the present invention, the spit driving unit comprises a casing affixed to one side of a housing of a rotisserie device; a motor mounted inside the casing, the motor having an output shaft extending out of the casing for rotating a spit on a top side of a roasting chamber defined within the housing; a power cord electrically connected with the motor and extending out of the casing for connection to an external power supply; a light source the pivotally mounted in the casing and electrically connected to the power cord for emitting light from a light emitting side thereof toward the roasting chamber defined within the housing; an adjustment handle pivotally mounted on the casing and coupled to the light source for adjusting the light emitting direction of the light source; a first switch mounted on the casing for switching on/off the motor; and a second switch the mounted on the casing for switching on/off the light source.

### BRIEF DESCRIPTION OF THE DRAWINGS

FIG. 1 is an elevational view of a conventional rotisserie device.

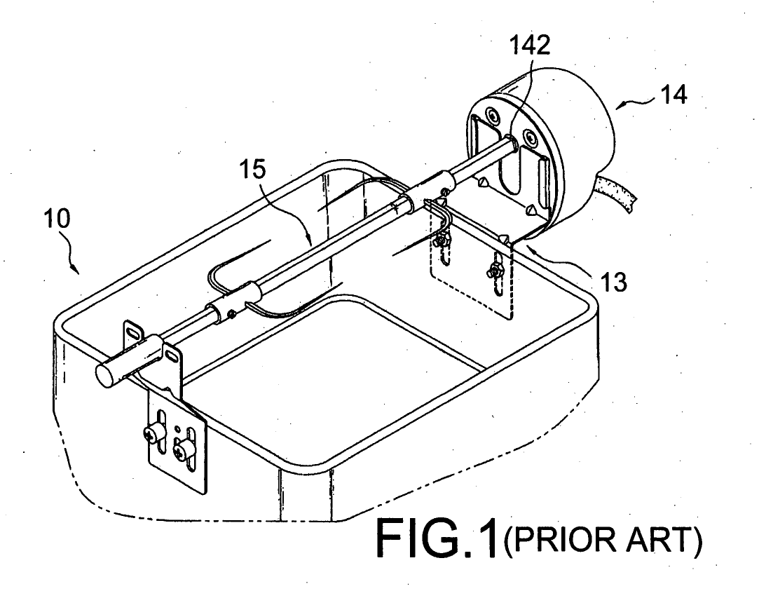

FIG. 2 is an oblique front elevation of a spit driving unit according to the present invention.

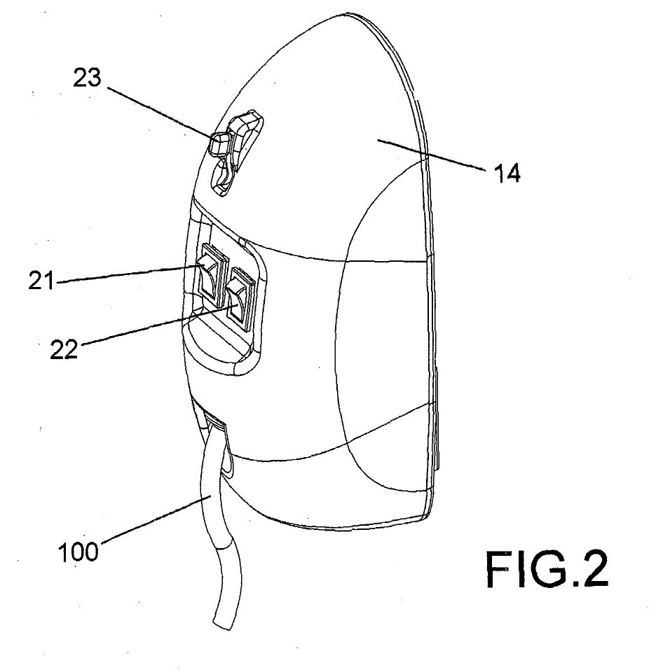

FIG. 3 is an oblique rear elevation of the spit driving unit according to the present invention.

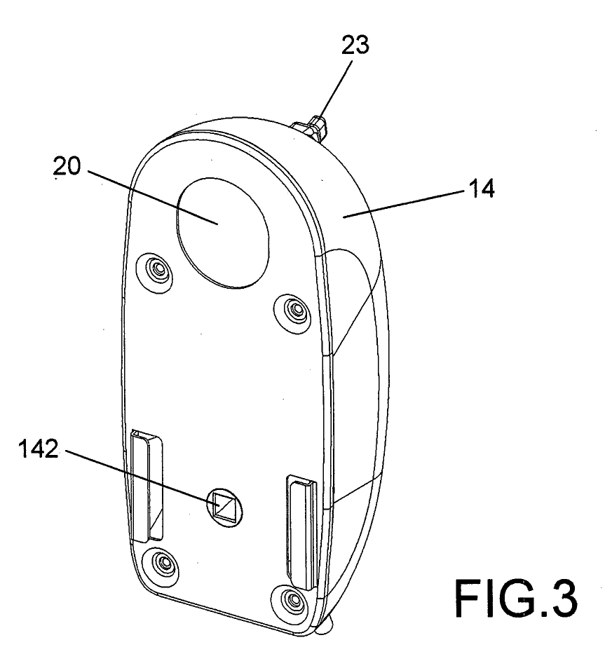

FIG. 4 is an exploded view of the spit driving unit according to the present invention.

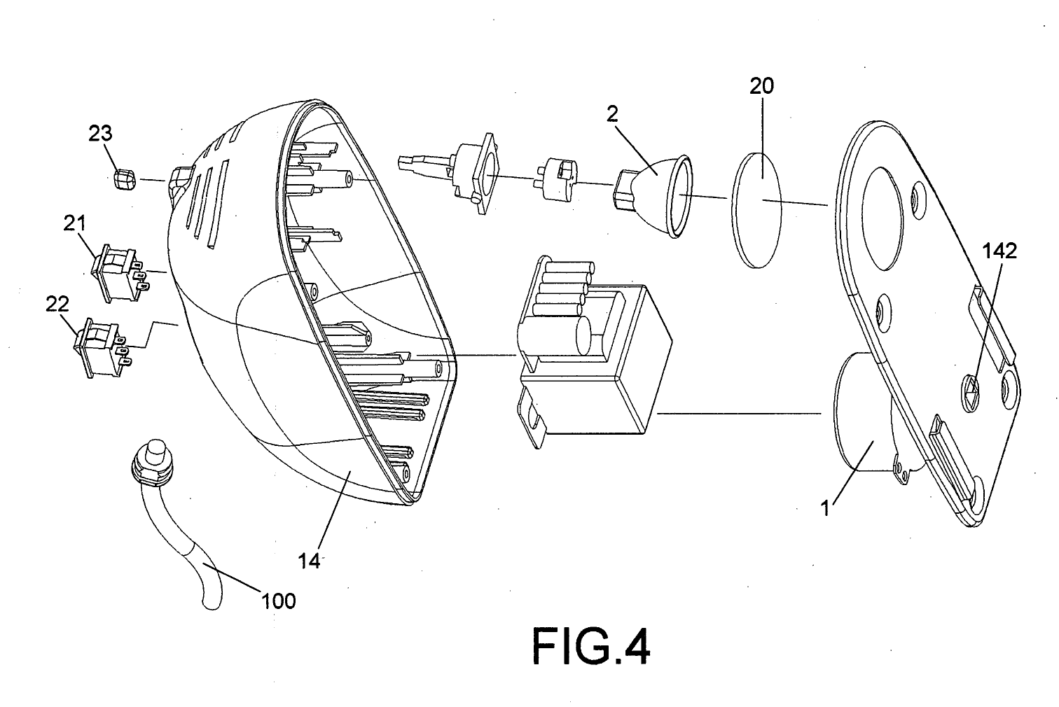

FIG. 5 is a sectional side view of the spit driving unit according to the present invention.

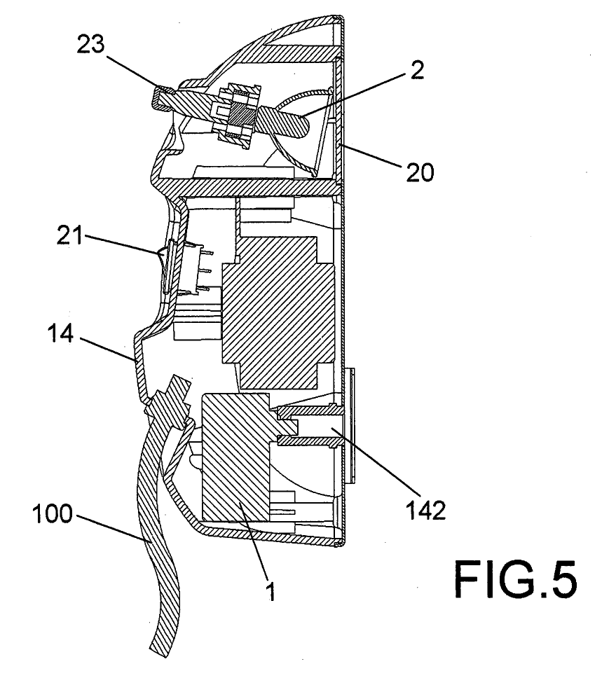

FIG. 6 corresponds to FIG. 5, showing the light emitting direction of the light source adjusted.

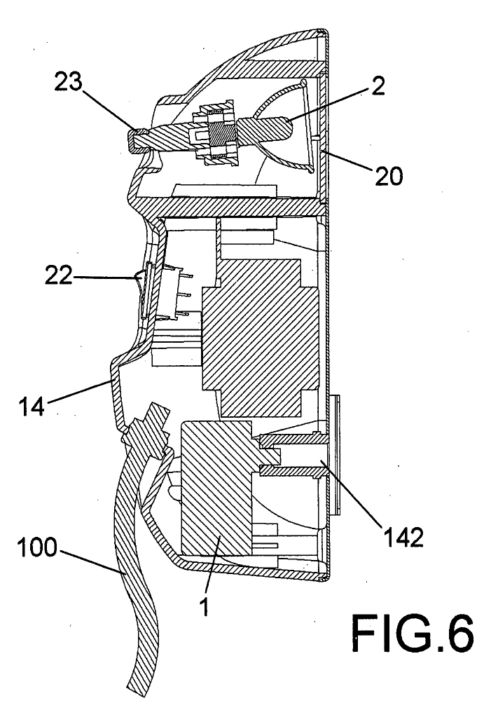

### DETAILED DESCRIPTION OF THE PREFERRED EMBODIMENT

Referring to the annexed drawings in detail, a spit driving unit for rotisserie device in accordance with the present invention is shown installed in a housing (not shown) of a rotisserie device for rotating a spit (not shown), comprising a casing 14 fixedly provided at one side of the housing of the rotisserie device, a motor 1 mounted inside the casing 14 and having an output shaft 142 extending out of the casing 14 for rotating a spit on the top side of the roasting chamber defined within the housing, a power cord 100 electrically connected with the motor 1 and extending out of the casing 14 for connection to power supply, a light source 2 pivotally mounted in the casing 14 and electrically connected to the power cord 100 for emitting light toward the roasting chamber defined within the housing of the rotisserie device, a lens 20 mounted on said casing 14 corresponding to the light emitting side of the light source 2 for condensing light from the light source 2 onto the roasting chamber defined within the housing 13, an adjustment handle 23 pivotally mounted on the casing 14 and coupled to the light source 2 for adjusting the light emitting direction of the light source 2, a first switch 21 mounted on the casing 14 for switching on/off the motor 1, and a second switch 22 mounted on the casing 14 for switching on/off the light source 2.

During installation, the casing 14 is affixed to one side of the housing of the rotisserie device, and then the spit 15 is supported on the housing of the rotisserie device and coupled to the output shaft 142 of the motor 1 for rotation with the output shaft 142, and then the power cord 100 is connected to the power supply. After the meat has been fastened to the spit 15, switch on the first switch 21 to start the motor 1. At this time, the meat is rotated with the spit 15 at the top side of the roasting chamber defined within the housing of the rotisserie device. When it is dark, switch on the second switch 22 to turn on the light source 2, causing the light source 2 to emit light through the lens 20 toward the roasting chamber for enabling the user to visually check the roasting condition of the meat. Further, the user can operate the adjustment handle 23 to adjust the light emitting direction of the light source 2. Further, the lens 20 well protects the light source 2 against contamination, facilitating cleaning.

As stated above, the invention provides a rotisserie device that is equipped with an angle-adjustable light source for illuminating the roasting chamber for enabling the user to visually check the roasting condition of the meat when it is dark.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A spit driving unit, comprising:
a casing affixed to one side of a housing of a rotisserie device;
a motor mounted inside said casing, said motor having an output shaft extending out of said casing for rotating a spit on a top side of a roasting chamber defined within said housing;
a power cord electrically connected with said motor and extending out of said casing for connection to an external power supply;
a light source pivotally mounted in said casing and electrically connected to said power cord for emitting light from a light emitting side thereof toward the roasting chamber defined within said housing;
an adjustment handle pivotally mounted on said casing and coupled to said light source for adjusting the light emitting direction of said light source;
a first switch mounted on said casing for switching on/off said motor; and
a second switch said mounted on the casing for switching on/off said light source.

2. The spit driving unit as claimed in claim 1, further comprising a lens mounted on an inner side of said casing corresponding to the light emitting side of said light source.
